(19) United States
(12) Patent Application Publication
(10) Pub. No.: US 2015/0127927 A1
(43) Pub. Date: May 7, 2015

(54) EFFICIENT HARDWARE DISPATCHING OF CONCURRENT FUNCTIONS IN MULTICORE PROCESSORS, AND RELATED PROCESSOR SYSTEMS, METHODS, AND COMPUTER-READABLE MEDIA

(71) Applicant: QUALCOMM INCORPORATED, San Diego, CA (US)

(72) Inventors: Michael William Paddon, Tokyo (JP); Erik Asmussen de Castro Lopo, Sydney (AU); Matthew Christian Duggan, Tokyo (JP); Kento Tarui, Tokyo (JP); Craig Matthew Brown, Freshwater (AU)

(73) Assignee: QUALCOMM INCORPORATED, San Diego, CA (US)

(21) Appl. No.: 14/224,619

(22) Filed: Mar. 25, 2014

Related U.S. Application Data
(60) Provisional application No. 61/898,745, filed on Nov. 1, 2013.

(51) Int. Cl. G06F 9/30

(52) U.S. Cl. CPC G06F 9/30043
USPC 712/225

(57) ABSTRACT

Embodiments of the disclosure provide efficient hardware dispatching of concurrent functions in multicore processors, and related processor systems, methods, and computer-readable media. In one embodiment, a first instruction indicating an operation requesting a concurrent transfer of program control is detected in a first hardware thread of a multicore processor. A request for the concurrent transfer of program control is enqueued in a hardware first-in-first-out (FIFO) queue. A second instruction indicating an operation dispatching the request for the concurrent transfer of program control in the hardware FIFO queue is detected in a second hardware thread of the multicore processor. The request for the concurrent transfer of program control is dequeued from the hardware FIFO queue, and the concurrent transfer of program control is executed in the second hardware thread. In this manner, functions may be efficiently and concurrently dispatched in context of multiple hardware threads, while minimizing contention management overhead.

### PRIORITY CLAIM

The present application claims priority to U.S. Provisional Patent Application Ser. No. 61/898,745 filed on Nov. 1, 2013 and entitled “EFFICIENT HARDWARE DISPATCHING OF CONCURRENT FUNCTIONS IN INSTRUCTION PROCESSING CIRCUITS, AND RELATED PROCESSOR SYSTEMS, METHODS, AND COMPUTER-READABLE MEDIA,” which is incorporated herein by reference in its entirety.

### BACKGROUND

I. Field of the Disclosure

The technology of the disclosure relates to processing of concurrent functions in multicore processor-based systems providing multiple processor cores and/or multiple hardware threads.

II. Background

A multicore processor, such as a central processing unit (CPU), found in contemporary digital computers may include multiple processor cores, or independent processing units, for reading and executing program instructions. Each processor core may include one or more hardware threads, and may also include additional resources accessible by the hardware threads, such as caches, floating point units (FPUs), and/or shared memory, as non-limiting examples. Each of the hardware threads includes a set of private physical registers capable of hosting a software thread and its context (e.g., general purpose registers (GPRs), program counters, and the like). The one or more hardware threads may be viewed by the multicore processor as logical processor cores, and thus may enable the multicore processor to execute multiple program instructions concurrently. In this manner, overall instruction throughput and program execution speeds may be improved.

The mainstream software industry has long faced challenges in developing concurrent software able to fully exploit the capabilities of modern multicore processors that provide multiple hardware threads. One developing area of interest focuses on taking advantage of the inherent parallelism provided by functional programming languages. Functional programming languages build on the concept of a “pure function.” A pure function is a unit of computation that is referentially transparent (i.e., it may be replaced in a program with its value without changing the effect of the program), and that is free of side effects (i.e., it does not modify an external state or have an interaction with any function external to itself). Two or more pure functions that do not share data dependencies may be executed in any order or in parallel by the CPU, and will yield the same results. Thus, such functions may be safely dispatched to separate hardware threads for concurrent execution.

Dispatching functions for concurrent execution raises a number of issues. To maximize utilization of available hardware threads, functions may be asynchronously dispatched into queues for evaluation. However, this may require a shared data area or data structure that is accessible by multiple hardware threads. As a result, it becomes necessary to handle contention issues, the number of which may increase exponentially as the number of hardware threads increases. Because functions may be relatively small units of computation, the realized benefits of concurrent execution of functions may be quickly outweighed by the overhead incurred by contention management.

Accordingly, it is desirable to provide support for efficient concurrent dispatching of functions in the context of multiple hardware threads while minimizing contention management overhead.

### SUMMARY OF THE DISCLOSURE

Embodiments of the disclosure provide efficient hardware dispatching of concurrent functions in multicore processors, and related processor systems, methods, and computer-readable media. In one embodiment, a multicore processor providing efficient hardware dispatching of concurrent functions is provided. The multicore processor includes a plurality of processing cores comprising a plurality of hardware threads. The multicore processor further comprises a hardware first-in-first-out (FIFO) queue communicatively coupled to the plurality of processing cores. The multicore processor also comprises an instruction processing circuit. The instruction processing circuit is configured to detect, in a first hardware thread of the plurality of hardware threads, a first instruction indicating an operation requesting a concurrent transfer of program control. The instruction processing circuit is further configured to enqueue a request for the concurrent transfer of program control into the hardware FIFO queue. The instruction processing circuit is also configured to detect, in a second hardware thread of the plurality of hardware threads, a second instruction indicating an operation dispatching the request for the concurrent transfer of program control in the hardware FIFO queue. The instruction processing circuit is additionally configured to dequeue the request for the concurrent transfer of program control from the hardware FIFO queue. The instruction processing circuit is also configured to execute the concurrent transfer of program control in the second hardware thread.

In another embodiment, a multicore processor providing efficient hardware dispatching of concurrent functions is provided. The multicore processor includes a hardware FIFO queue means, and a plurality of processing cores comprising a plurality of hardware threads and communicatively coupled to the hardware FIFO queue means. The multicore processor further includes an instruction processing circuit means, comprising a means for detecting, in a first hardware thread of the plurality of hardware threads, a first instruction indicating an operation requesting a concurrent transfer of program control. The instruction processing circuit means also comprises a means for enqueuing a request for the concurrent transfer of program control into the hardware FIFO queue means. The instruction processing circuit means further comprises a means for detecting, in a second hardware thread of the plurality of hardware threads, a second instruction indicating an operation dispatching the request for the concurrent transfer of program control in the hardware FIFO queue means. The instruction processing circuit means additionally comprises a means for dequeuing the request for the concurrent transfer of program control from the hardware FIFO queue means. The instruction processing circuit means also comprises a means for executing the concurrent transfer of program control in the second hardware thread.

In another embodiment, a method for efficient hardware dispatching of concurrent functions is provided. The method comprises detecting, in a first hardware thread of a multicore processor, a first instruction indicating an operation requesting a concurrent transfer of program control. The method further comprises enqueuing a request for the concurrent transfer of program control into a hardware FIFO queue. The method also comprises detecting, in a second hardware thread of the multicore processor, a second instruction indicating an operation dispatching the request for the concurrent transfer of program control in the hardware FIFO queue. The method additionally comprises dequeuing the request for the concurrent transfer of program control from the hardware FIFO queue. The method further comprises executing the concurrent transfer of program control in the second hardware thread.

In another embodiment, a non-transitory computer-readable medium, having stored thereon computer-executable instructions to cause a processor to implement a method for efficient hardware dispatching of concurrent functions is provided. The method implemented by the computer-executable instructions comprises detecting, in a first hardware thread of a multicore processor, a first instruction indicating an operation requesting a concurrent transfer of program control. The method implemented by the computer-executable instructions further comprises enqueuing a request for the concurrent transfer of program control into a hardware FIFO queue. The method implemented by the computer-executable instructions also comprises detecting, in a second hardware thread of the multicore processor, a second instruction indicating an operation dispatching the request for the concurrent transfer of program control in the hardware FIFO queue. The method implemented by the computer-executable instructions additionally comprises dequeuing the request for the concurrent transfer of program control from the hardware FIFO queue. The method implemented by the computer-executable instructions further comprises executing the concurrent transfer of program control in the second hardware thread.

### BRIEF DESCRIPTION OF THE FIGURES

FIG. 1 is a block diagram illustrating a multicore processor for providing efficient hardware dispatching of concurrent functions, including an instruction processing circuit;

FIG. 2 is a diagram illustrating processing flows for exemplary instruction streams by the instruction processing circuit of FIG. 1 using a hardware first-in-first-out (FIFO) queue;

FIG. 3 is a flowchart illustrating exemplary operations of the instruction processing circuit of FIG. 1 for efficiently dispatching concurrent functions;

FIG. 4 is a diagram illustrating elements of a CONTINUE instruction for requesting a concurrent transfer of program control, as well as elements of a resulting request for the concurrent transfer of program control;

FIG. 5 is a flowchart illustrating in greater detail exemplary operations of the instruction processing circuit of FIG. 1 for enqueuing a request for concurrent transfer of program control;

FIG. 6 is a flowchart illustrating in greater detail exemplary operations of the instruction processing circuit of FIG. 1 for dequeuing a request for concurrent transfer of program control;

FIG. 7 is a diagram illustrating in greater detail processing flows for exemplary instruction streams by the instruction processing circuit of FIG. 1 to provide efficient hardware dispatching of concurrent functions, including a mechanism for returning program control to an originating hardware thread; and

FIG. 8 is a block diagram of an exemplary processor-based system that can include the multicore processor and the instruction processing circuit of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments of the disclosure provide efficient hardware dispatching of concurrent functions in multicore processors, and related processor systems, methods, and computer-readable media. In one embodiment, a multicore processor providing efficient hardware dispatching of concurrent functions is provided. The multicore processor includes a plurality of processing cores comprising a plurality of hardware threads. The multicore processor further comprises a hardware first-in-first-out (FIFO) queue communicatively coupled to the plurality of processing cores. The multicore processor also comprises an instruction processing circuit. The instruction processing circuit is configured to detect, in a first hardware thread of the plurality of hardware threads, a first instruction indicating an operation requesting a concurrent transfer of program control. The instruction processing circuit is further configured to enqueue a request for the concurrent transfer of program control into the hardware FIFO queue. The instruction processing circuit is also configured to detect, in a second hardware thread of the plurality of hardware threads, a second instruction indicating an operation dispatching the request for the concurrent transfer of program control in the hardware FIFO queue. The instruction processing circuit is additionally configured to dequeue the request for the concurrent transfer of program control from the hardware FIFO queue. The instruction processing circuit is also configured to execute the concurrent transfer of program control in the second hardware thread.

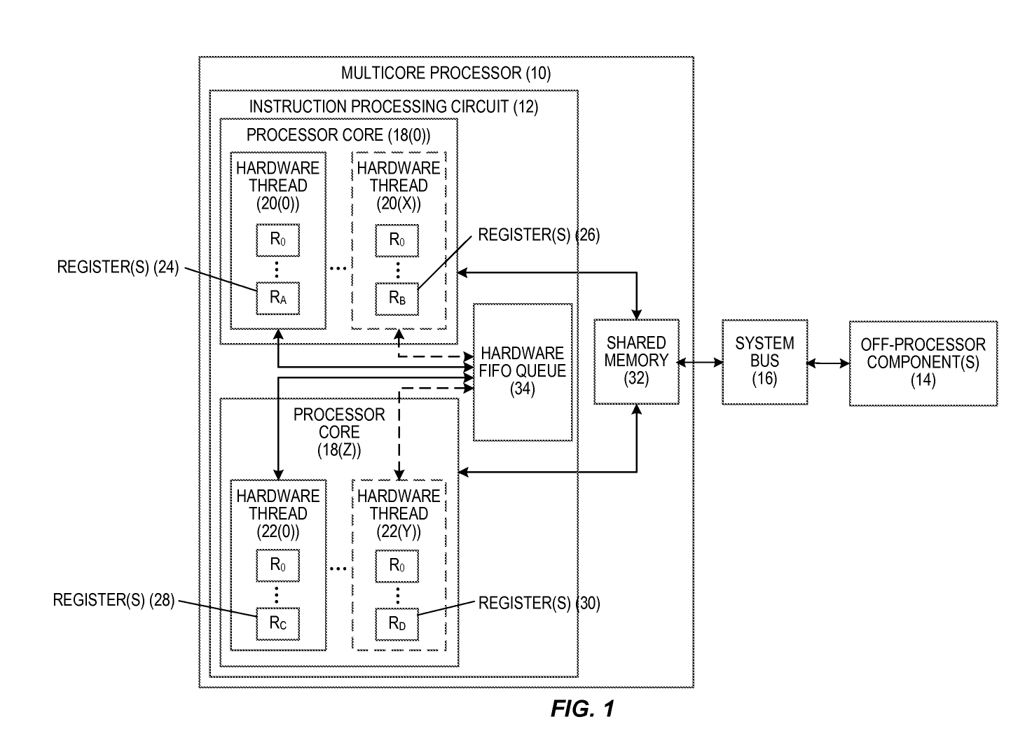

In this regard, FIG. 1 is a block diagram of an exemplary multicore processor 10 for efficient hardware dispatching of concurrent functions. In particular, the multicore processor 10 provides an instruction processing circuit 12 for enqueueing and dispatching requests for concurrent transfers of program control. The multicore processor 10 encompasses one or more of any of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor dies or packages. The multicore processor 10 may be communicatively coupled to one or more off-processor components 14 (e.g., memory, input devices, output devices, network interface devices, and/or display controllers, as non-limiting examples) via a system bus 16.

The multicore processor 10 of FIG. 1 includes a plurality of processor cores 18(0)-18(Z). Each of the processor cores 18 is a processing unit that may read and process computer program instructions (not shown) independently of and concurrently with other processor cores 18. As seen in FIG. 1, the multicore processor 10 includes two processor cores 18(0) and 18(Z). However, it is to be understood that some embodiments may include more processor cores 18 than the two processor cores 18(0) and 18(Z) illustrated in FIG. 1.

The processor cores 18(0) and 18(Z) of the multicore processor 10 include hardware threads 20(0)-20(X) and hardware threads 22(0)-22(Y), respectively. Each of the hardware threads 20, 22 executes independently, and may be viewed as a logical core by the multicore processor 10 and/or by an operating system or other software (not shown) being executed by the multicore processor 10. In this manner, the processor cores 18 and the hardware threads 20, 22 may provide a superscalar architecture permitting concurrent multithreaded execution of program instructions. In some embodiments, the processor cores 18 may include fewer or more hardware threads 20, 22 than shown in FIG. 1. Each of the hardware threads 20, 22 may include dedicated resources, such as general purpose registers (GPRs) and/or control registers, for storing a current state of program execution. In the example of FIG. 1, the hardware threads 20(0) and 20(X) include registers 24 and 26, respectively, while the hardware threads 22(0) and 22(Y) include registers 28 and 30, respectively. In some embodiments, the hardware threads 20, 22 may also share other storage or execution resources with other hardware threads 20, 22 that are executing on the same processor core 18.

The independent execution capability of the hardware threads 20, 22 enables the multicore processor 10 to dispatch functions that do not share data dependencies (i.e., pure functions) to the hardware threads 20, 22 for concurrent execution. One approach for maximizing the utilization of the hardware threads 20, 22 is to asynchronously dispatch functions into queues for evaluation. This approach, however, may require a shared data area or data structure, such as shared memory 32 of FIG. 1. The use of the shared memory 32 by multiple hardware threads 20, 22 may lead to contention issues, the number of which may increase exponentially as the number of hardware threads 20, 22 increases. As a result, the overhead incurred by handling these contention issues may outweigh the realized benefits of concurrent execution of functions by the hardware threads 20, 22.

In this regard, the instruction processing circuit 12 of FIG. 1 is provided by the multicore processor 10 for efficient hardware dispatching of concurrent functions. The instruction processing circuit 12 may include the processor cores 18, and further includes a hardware FIFO queue 34. As used herein, a “hardware FIFO queue” includes any FIFO device for which contention management is handled in hardware and/or in microcode. In some embodiments, the hardware FIFO queue 34 may be implemented entirely on die, and/or may be implemented using memory managed by dedicated registers (not shown).

The instruction processing circuit 12 defines a machine instruction (not shown) for enqueueing a request for a concurrent transfer of program control from one of the hardware threads 20, 22 into the hardware FIFO queue 34. The instruction processing circuit 12 further defines a machine instruction (not shown) for dequeuing requests from the hardware FIFO queue 34, and executing the requested transfer of program control in a currently executing one of the hardware threads 20, 22. By providing machine instructions for enqueueing and dequeuing requests for concurrent transfer of program control to and from the hardware FIFO queue 34, the instruction processing circuit 12 may enable more efficient utilization of multiple hardware threads 20, 22 in a multicore processing environment.

According to some embodiments described herein, a single hardware FIFO queue 34 may be provided for enqueueing requests for concurrent transfer of program control for execution in any one of the hardware threads 20, 22. Some embodiments may provide multiple hardware FIFO queues 34, with one hardware FIFO queue 34 dedicated to each one of the hardware threads 20, 22. In such embodiments, a request for concurrent execution of a function in a specified one of the hardware threads 20, 22 may be enqueued in the hardware FIFO queue 34 corresponding to the specified one of the hardware threads 20, 22. In some embodiments, an additional hardware FIFO queue may also be provided for enqueueing requests for concurrent transfer of program control that are not directed to a particular one of the hardware threads 20, 22, and/or that may execute in any one of the hardware threads 20, 22.

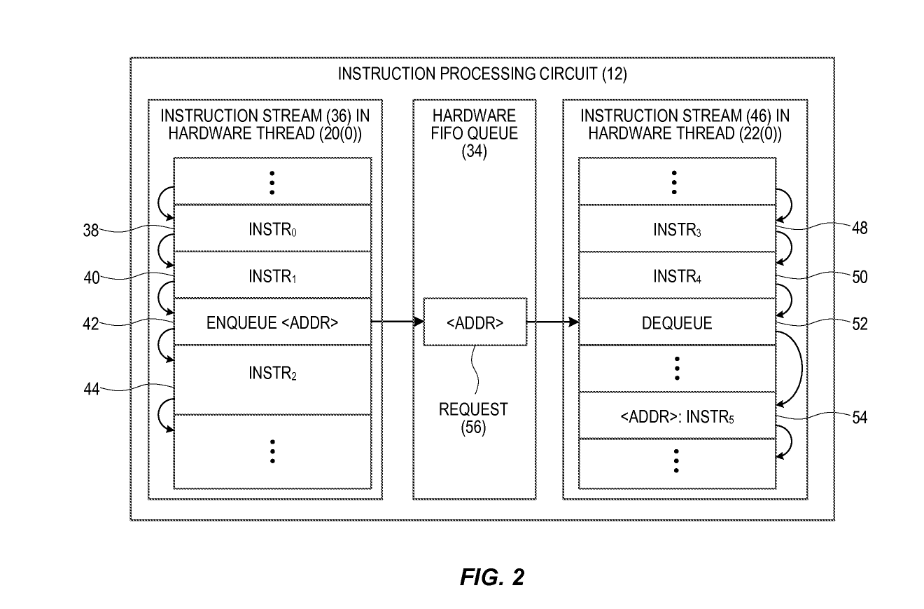

To illustrate processing flows for exemplary instruction streams by the instruction processing circuit 12 of FIG. 1 using the hardware FIFO queue 34, FIG. 2 is provided. FIG. 2 shows an instruction stream 36, comprising a series of instructions 38, 40, 42, and 44 being executed by the hardware thread 20(0) of FIG. 1. Similarly, an instruction stream 46 includes a series of instructions 48, 50, 52, and 54 being executed by the hardware thread 22(0). It is to be understood that, although the processing flows for the instruction streams 36 and 46 are described sequentially below, the instruction streams 36 and 46 are being executed concurrently by the respective hardware threads 20(0) and 22(0). It is to be further understood that each of the instruction streams 36 and 46 may be executed in any one of the hardware threads 20, 22.

As seen in FIG. 2, execution of instructions in the instruction stream 36 proceeds from the instruction 38 to the instruction 40, and then to the instruction 42. In this example, the instructions 38 and 40 are designated Instr0 and Instr1, respectively, and may represent any instructions executable by the multicore processor 10. Execution then continues to the instruction 42, which is an Enqueue instruction that includes a parameter <addr>. The Enqueue instruction 42 indicates an operation requesting a concurrent transfer of program control to the address specified by the parameter <addr>. Stated differently, the Enqueue instruction 42 requests that a function having its first instruction stored at the address specified by the parameter <addr> be concurrently executed while the processing in the hardware thread 20(0) continues.

In response to detecting the Enqueue instruction 42, the instruction processing circuit 12 enqueues a request 56 in the hardware FIFO queue 34. The request 56 includes the address specified by the parameter <addr> of the Enqueue instruction 42. After enqueueing the request 56, processing of the instruction stream 36 in the hardware thread 20(0) continues with the next instruction 44 (designated as Instr₂) following the Enqueue instruction 42.

Concurrently with the program flow of the instruction stream 36 in the hardware thread 20(0) described above, instruction execution in the instruction stream 46 of the hardware thread 22(0) proceeds from the instruction 48 to the instruction 50, and then to the instruction 52. The instructions 48 and 50 are designated as Instr₃ and Instr₄, respectively, and may represent any instructions executable by the multicore processor 10. The instruction 52 is a Dequeue instruction that causes an oldest request in the hardware FIFO queue 34 (in this instance, the request 56) to be dispatched from the hardware FIFO queue 34. The Dequeue instruction 52 also causes program control in the hardware thread 22(0) to be transferred to the address <addr> specified by the request 56. As seen in FIG. 2, the Dequeue instruction 52 thus transfers program control in the hardware thread 22(0) to the instruction 54 (designated as Instr₅) at the address <addr>. Processing of the instruction stream 46 in the hardware thread 22(0) then continues with the next instruction (not shown) following the instruction 54. In this manner, a function beginning with the instruction 54 may execute in the hardware thread 22(0) concurrently with execution of the instruction stream 36 in the hardware thread 20(0).

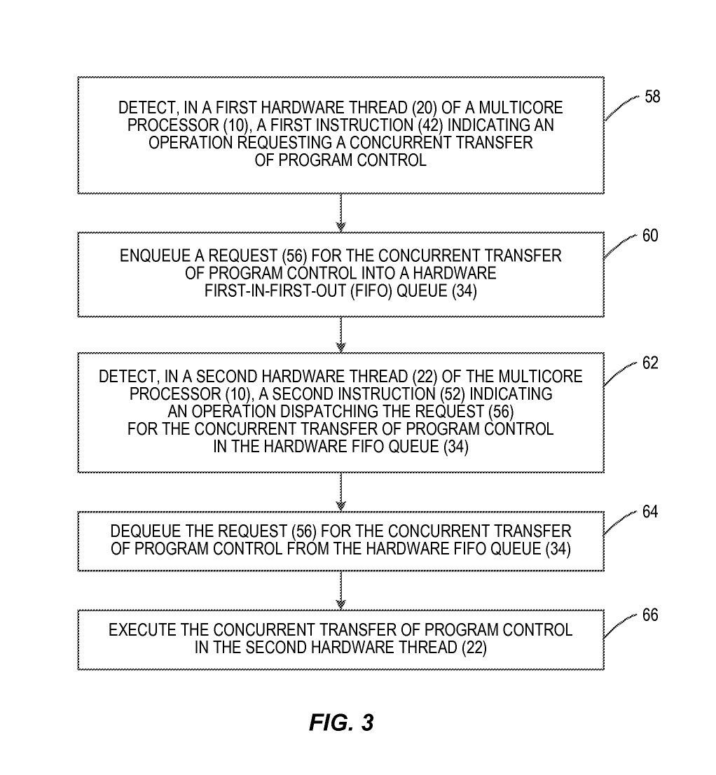

FIG. 3 is a flowchart illustrating exemplary operations of the instruction processing circuit 12 of FIG. 1 for efficiently dispatching concurrent functions. For the sake of clarity, elements of FIGS. 1 and 2 are referenced in describing FIG. 3. Processing in FIG. 3 begins with the instruction processing circuit 12 detecting, in a first hardware thread 20 of the multicore processor 10, a first instruction 42 indicating an operation requesting a concurrent transfer of program control (block 58). In some embodiments, the first instruction 42 may be a CONTINUE instruction provided by the multicore processor 10. The first instruction 42 may specify a target address to which program control is to be concurrently transferred. As discussed in greater detail below, the first instruction 42 may optionally include a register mask indicating that a content of one or more registers (such as registers 24, 26, 28, 30) may be transferred. Some embodiments may provide that an identifier of a target hardware thread may be optionally included, to indicate a hardware thread 20, 22 to which the concurrent transfer of program control is to be made.

The instruction processing circuit 12 then enqueues a request 56 for the concurrent transfer of program control into the hardware FIFO queue 34 (block 60). The request 56 may include an address parameter indicating the address to which program control is to be concurrently transferred. As discussed further below, the request 56 in some embodiments may include one or more register identities and one or more register contents corresponding to one or more registers specified by the optional register mask of the first instruction 42.

The instruction processing circuit 12 next detects, in a second hardware thread 22 of the multicore processor 10, a second instruction 52 indicating an operation dispatching the request 56 for the concurrent transfer of program control in the hardware FIFO queue 34 (block 62). In some embodiments, the second instruction 52 may be a DISPATCH instruction provided by the multicore processor 10. The instruction processing circuit 12 dequeues the request 56 for the concurrent transfer of program control from the hardware FIFO queue 34 (block 64). The concurrent transfer of program control is then executed in the second hardware thread 22 (block 66).

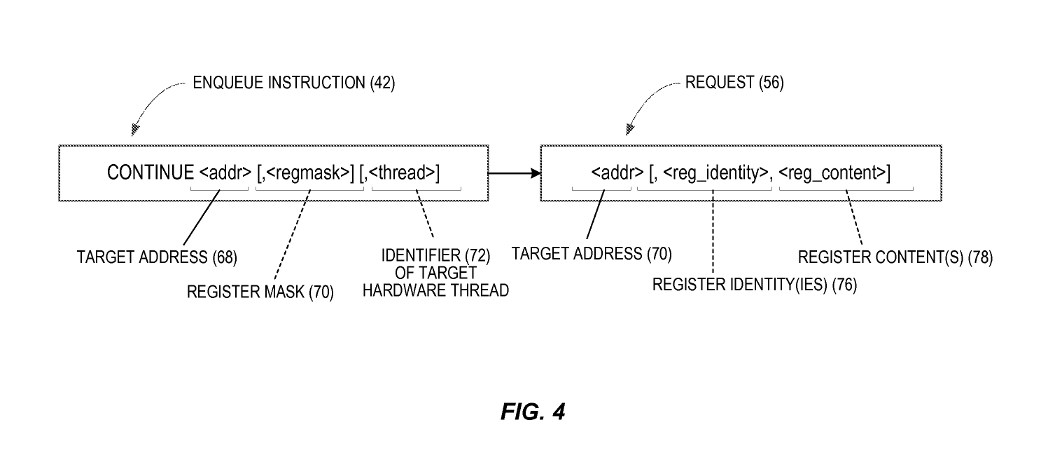

As noted above, an instruction indicating a request for a concurrent transfer of program control, such as the first instruction 42 of FIG. 2, may include optional parameters for specifying register contents to be transferred, as well as for specifying a target hardware thread. Accordingly, FIG. 4 is provided to illustrate constituent elements of an exemplary Enqueue instruction 42 for requesting a concurrent transfer of program control, as well as elements of an exemplary request 56 for concurrent transfer of program control. In the example of FIG. 4, the Enqueue instruction 42 is a CONTINUE instruction. It is to be understood that, in some embodiments, the Enqueue instruction 42 may be designated by a different instruction name. The Enqueue instruction 42 includes a target address 68 (“<addr>”), as well as an optional register mask 70 (“<regmask>”) and an optional identifier 72 of a target hardware thread (“<thread>”). The target address 68 specifies the address to which a program control transfer is requested, and is included in the request 56 as a target address 74 (“<addr>”).

In some embodiments, the Enqueue instruction 42 may also include the register mask 70, which indicates one or more registers (such as one or more of register 24, 26, 28, or 30). If the register mask 70 is present, the instruction processing circuit 12 includes one or more register identities 76 (“<reg_identity>”) and one or more register contents 78 (“<reg_content>”) in the request 56 for each register specified by the register mask 70. Using the one or more register identities 76 and the one or more register contents 78, a current context of a first hardware thread in which the Enqueue instruction 42 is executed may subsequently be restored upon dispatch of the request 56 in a second hardware thread.

Some embodiments may provide that the Enqueue instruction 42 includes an optional identifier 72 of a target hardware thread to which the concurrent transfer of program control is desired. Accordingly, at the time the Enqueue instruction 42 is executed, the identifier 72 may be used by the instruction processing circuit 12 to select one of multiple hardware FIFO queues 34 in which to enqueue the request 56. For example, in some embodiments, the instruction processing circuit 12 may enqueue the request 56 in a hardware FIFO queue 34 corresponding to the hardware thread 20, 22 specified by the identifier 72. Some embodiments may also provide a hardware FIFO queue 34 dedicated to enqueueing requests for which no identifier 72 is provided by the Enqueue instruction 42.

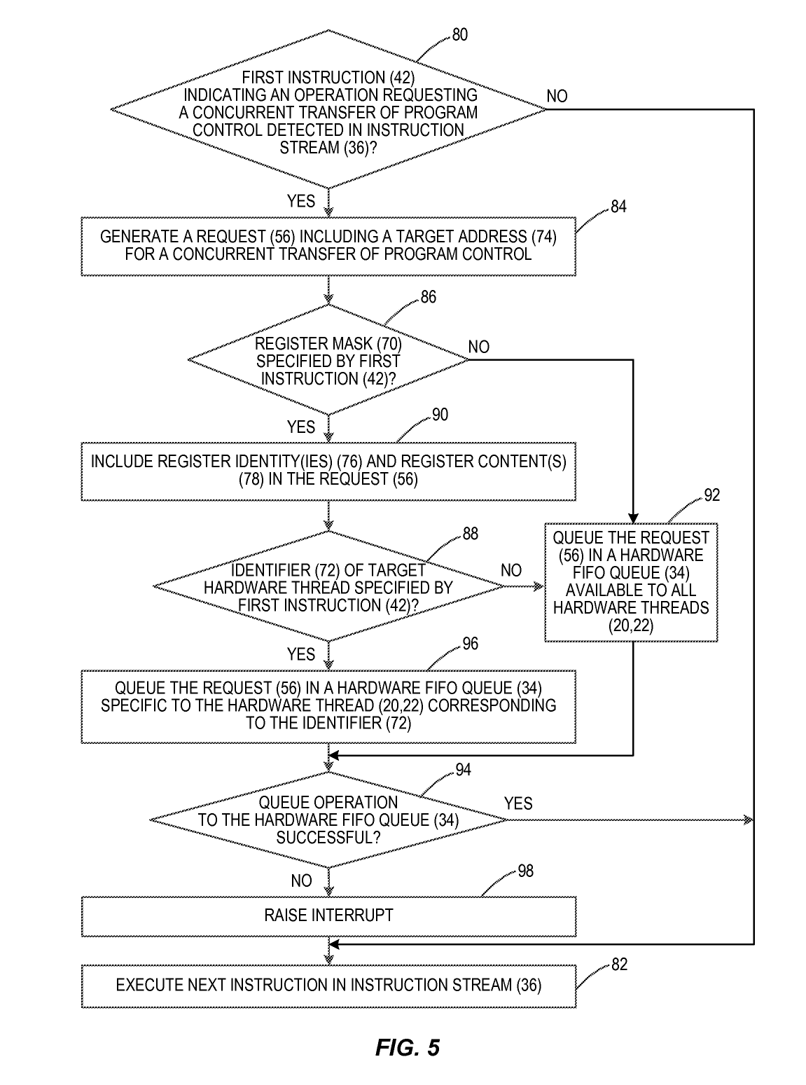

FIG. 5 is a flowchart illustrating in greater detail exemplary operations of the instruction processing circuit 12 of FIG. 1 for enqueuing a request 56 for concurrent transfer of program control, as referenced above in block 60 of FIG. 3. For purposes of clarity, elements of FIGS. 1, 2, and 4 are referenced in describing FIG. 5. In the example of FIG. 5, the operations for enqueueing the request 56 for concurrent transfer of program control are discussed with respect to the instruction stream 36 of the hardware thread 20(0), as seen in FIG. 2. However, it is to be understood that the operations of FIG. 5 may be executed in an instruction stream in any one of the hardware threads 20, 22.

In FIG. 5, operations begin with the instruction processing circuit 12 determining whether a first instruction 42 indicating an operation requesting a concurrent transfer of program control is detected in the instruction stream 36 in the hardware thread 20(0) (block 80). In some embodiments, the first instruction 42 may be a CONTINUE instruction. If the first instruction 42 is not detected, processing resumes at block 82. If the first instruction 42 indicating an operation requesting a concurrent transfer of program control is detected at block 80, the instruction processing circuit 12 creates the request 56 including a target address 74 for concurrent transfer of program control (block 84).

The instruction processing circuit 12 next examines whether the first instruction 42 specifies the register mask 70 (block 86). In some embodiments, the register mask 70 may specify one or more registers 24 of the hardware thread 20(0), the contents of which may be included in the request 56 to preserve the current context of the hardware thread 20(0). If no register mask 70 is specified, processing continues at block 88. However, if it is determined at block 86 that a register mask 70 is specified by the first instruction 42, the instruction processing circuit 12 includes one or more register identities 76 and one or more register contents 78 corresponding to each register 24 specified by the register mask 70 in the request 56 (block 90).

The instruction processing circuit 12 then determines whether the first instruction 42 specifies an identifier 72 of a target hardware thread (block 88). If no identifier 72 is specified (i.e., the first instruction 42 is not requesting a concurrent transfer of program control to a specific hardware thread), the request 56 is queued in a hardware FIFO queue 34 that is available to all hardware threads 20, 22 (block 92). Processing then continues at block 94. If the instruction processing circuit 12 determines at block 88 that an identifier 72 of a target hardware thread is specified by the first instruction 42, the request 56 is queued in a hardware FIFO queue 34 that is specific to the one of the hardware threads 20, 22 corresponding to the identifier 72 (block 96).

The instruction processing circuit 12 next determines whether the queue operation for enqueueing the request 56 in the hardware FIFO queue 34 was successful (block 94). If so, processing continues at block 82. If the request 56 could not be queued in the hardware FIFO queue 34 (e.g., because the hardware FIFO queue 34 was full), an interrupt is raised (block 98). Processing then continues with the execution of a next instruction in the instruction stream 36 (block 82).

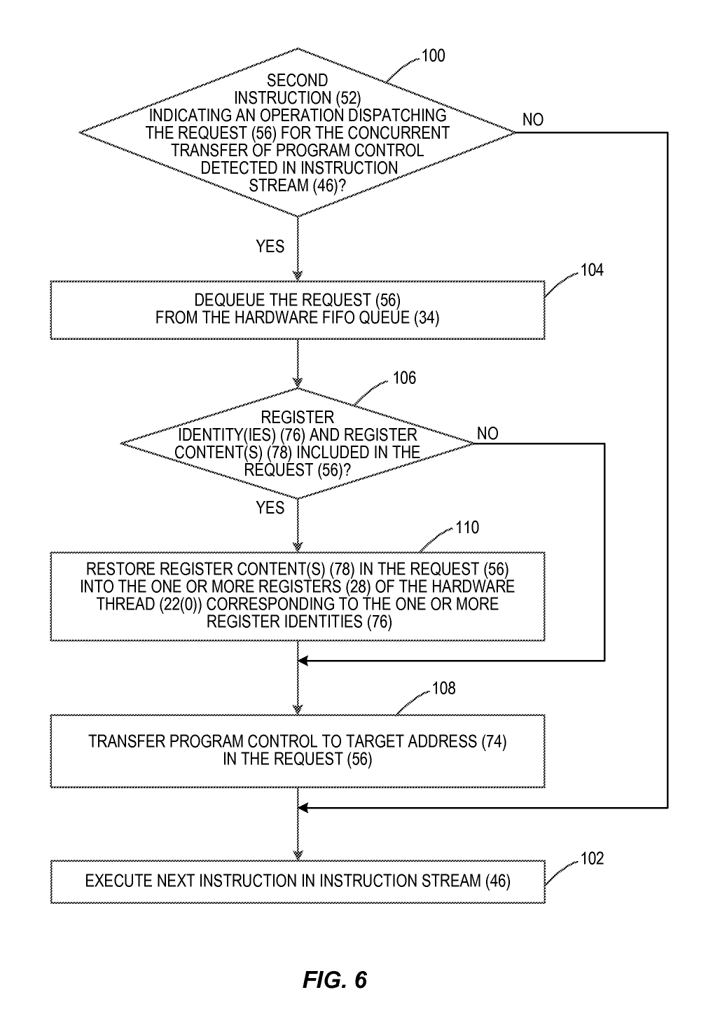

FIG. 6 illustrates in greater detail exemplary operations of the instruction processing circuit 12 of FIG. 1 for dequeuing a request 56 for concurrent transfer of program control, as referenced above in block 64 of FIG. 3. Elements of FIGS. 1, 2, and 4 are referenced in describing FIG. 6, for purposes of clarity. In the example of FIG. 6, the operations for dequeueing the request 56 for concurrent transfer of program control are discussed with respect to the instruction stream 46 of the hardware thread 22(0) as seen in FIG. 2. However, it is to be understood that the operations of FIG. 6 may be executed in an instruction stream in any one of the hardware threads 20, 22.

As seen in FIG. 6, operations begin with the instruction processing circuit 12 determining whether a second instruction 52 indicating an operation dispatching the request 56 for concurrent transfer of program control is detected in the instruction stream 46 (block 100). In some embodiments, the second instruction 52 may comprise a DISPATCH instruction. If the second instruction 52 is not detected, processing continues at block 102. If the second instruction 52 is detected in the instruction stream 46, the request 56 is dequeued from the hardware FIFO queue 34 by the instruction processing circuit 12 (block 104).

The instruction processing circuit 12 then examines the request 56 to determine whether one or more register identities 76 and one or more register contents 78 are included in the request 56 (block 106). If not, processing continues at block 108. If the one or more register identities 76 and the one or more register contents 78 are included in the request 56, the instruction processing circuit 12 restores the one or more register contents 78 in the request 56 into the one or more registers 28 of the hardware thread 22(0) corresponding to the one or more register identities 76 (block 110). In this manner, the context of the hardware thread 20(0) at the time the request 56 was enqueued may be restored in the hardware thread 22(0). The instruction processing circuit 12 then transfers program control in the hardware thread 22(0) to the target address 74 in the request 56 (block 108). Processing continues with the execution of a next instruction in the instruction stream 46 (block 102).

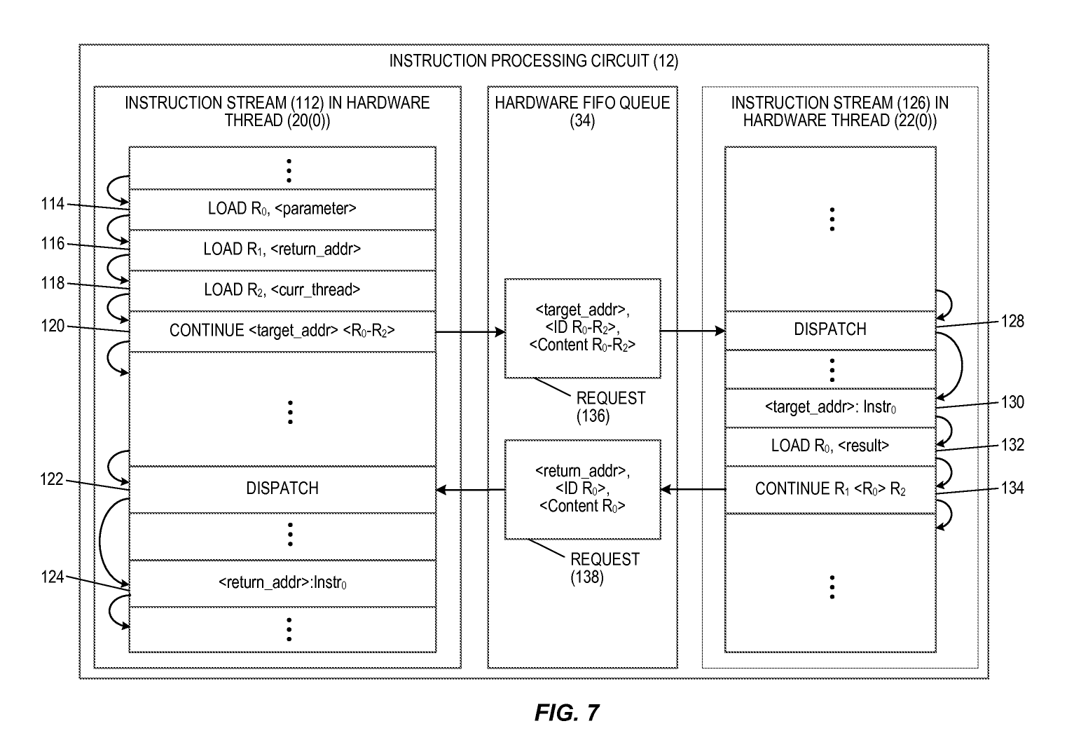

FIG. 7 is a diagram illustrating, in greater detail, processing flows for exemplary instruction streams by the instruction processing circuit 12 of FIG. 1 to provide efficient hardware dispatching of concurrent functions. In particular, FIG. 7 illustrates a mechanism by which program control may be returned to an originating hardware thread after a concurrent transfer. In FIG. 7, an instruction stream 112, comprising a series of instructions 114, 116, 118, 120, 122, and 124, is executed by the hardware thread 20(0) of FIG. 1, while an instruction stream 126, including a series of instructions 128, 130, 132, and 134, is executed by the hardware thread 22(0). It is to be understood that, although the processing flows for the instruction streams 112 and 126 are described sequentially below, the instruction streams 112 and 126 are executed concurrently by the respective hardware threads 20(0) and 22(0). It is to be further understood that each of the instruction streams 112 and 126 may be executed in any one of the hardware threads 20, 22.

As shown in FIG. 7, the instruction stream 112 begins with LOAD instructions 114, 116, and 118, each of which stores a value in one of the registers 24 of the hardware thread 20(0). The first LOAD instruction 114 indicates that a value <parameter> is to be stored in a register referred to as R₀. The value <parameter> may be an input value that is intended to be consumed by a function that will be executed concurrently with the instruction stream 112. The next instruction executed in the instruction stream 112 is the LOAD instruction 116, which indicates that a value <return_addr> is to be stored in one of the registers 24 (designated as R₁). The value <return_addr> stored in R₁ represents the address in the hardware thread 20(0) to which program control will return once the concurrently-executed function completes its processing. Following the LOAD instruction 116 is the LOAD instruction 118, which indicates that a value <curr_thread> is to be stored in one of the registers 24 (referred to here as R₂). The value <curr_thread> represents an identifier 72 for the hardware thread 20(0), and indicates the hardware thread 20 to which program control should return once the concurrently-executed function concludes its processing.

A CONTINUE instruction 120 is then executed in the instruction stream 112 by the instruction processing circuit 12. The CONTINUE instruction 120 specifies a parameter <target_addr> and a register mask <R₀-R₂>. The parameter <target_addr> of the CONTINUE instruction 120 indicates the address of the function to be concurrently executed. The parameter <R₀-R₂> is a register mask 70 indicating that register identities 76 and register contents 78 corresponding to registers R₀, R₁, and R₂ of the hardware thread 20(0) are to be included in the request 56 for concurrent transfer of program control that is generated by execution of the CONTINUE instruction 120.

Upon detection and execution of the CONTINUE instruction 120, the instruction processing circuit 12 enqueues a request 136 in the hardware FIFO queue 34. In this example, the request 136 includes the address specified by the parameter <target_addr> of the CONTINUE instruction 120, and further includes register identities 76 for the registers R₀-R₂ (designated as <ID R₀-R₂>) and corresponding register contents 78 of the registers R₀-R₂ (referred to as <Content R₀-R₂>). After enqueueing the request 136, processing of the instruction stream 112 continues with the next instruction following the CONTINUE instruction 120.

Concurrently with the program flow of the instruction stream 112 in the hardware thread 20(0) described above, the instruction stream 126 is executed in the hardware thread 22(0), eventually reaching the DISPATCH instruction 128. The DISPATCH instruction 128 indicates an operation dispatching the oldest request in the hardware FIFO queue 34 (in this instance, the request 136). Upon dispatching the request 136, the instruction processing circuit 12 uses the register identities 76 <ID R₀-R₂> and the register contents 78 <Content R₀-R₂> of the request 136 to restore the values of registers R₀-R₂ of the registers 28 in the hardware thread 22(0), which correspond to the registers R₀-R₂ of the hardware thread 20(0). Program control in the hardware thread 22(0) is then transferred to the instruction 130 located at the address indicated by the parameter <target_address> of the request 136.

Execution of the instruction stream 126 continues with the instruction 130. In this example, the instruction 130 is designated as Instr₀, and may represent one or more instructions for carrying out a desired functionality or calculating a desired result. The instruction(s) Instr₀ may use the value originally stored in the register R₀ of the hardware thread 20(0) and currently stored in the register R₀ of the hardware thread 22(0) as an input to calculate a result value (“<result>”). The instruction stream 126 next proceeds to a LOAD instruction 132, which indicates that the calculated result value <result> is to be loaded into the register R₀ of the hardware thread 22(0).

A CONTINUE instruction 134 is then executed in the instruction stream 126 by the instruction processing circuit 12. The CONTINUE instruction 134 specifies parameters including a content of the register R₁ of the hardware thread 22(0), a register mask <R₀>, and a content of the register R₂ of the hardware thread 22(0). As noted above, the content of the register R₁ of the hardware thread 22(0) is the value <return_addr> stored in the register R₁ of the hardware thread 20(0), and indicates the return address to which processing is to resume in the hardware thread 20(0). The register mask <R₀> indicates that a register identity 76 and a register content 78 corresponding to the register R₀ of the hardware thread 22(0) is to be included in the request for concurrent transfer of program control generated in response to the CONTINUE instruction 134. As noted above, the register R₀ of the hardware thread 22(0) stores the result of the concurrently executed function. The content of the register R₂ of the hardware thread 22(0) is the value <curr_thread> stored in the register R₂ of the hardware thread 20(0), and indicates the hardware thread 20, 22 in which the request generated by the CONTINUE instruction 134 should be dequeued.

In response to detecting the CONTINUE instruction 134, the instruction processing circuit 12 enqueues a request 138 in the hardware FIFO queue 34. In this example, the request 138 includes the value <return_addr> specified by the parameter R₀ of the CONTINUE instruction 134, and further includes a register identity 76 for the register R₀ of the hardware thread 22(0) (designated as <ID R₀>) and a register content 78 of the register R₀ of the hardware thread 22(0) (referred to as <Content R₀>). After enqueueing the request 138, processing of the instruction stream 126 continues with the next instruction following the CONTINUE instruction 134.

Returning now to the instruction stream 112 in the hardware thread 20(0), a DISPATCH instruction 122 is encountered in the instruction stream 112. The DISPATCH instruction 122 indicates an operation dispatching the oldest request in the hardware FIFO queue 34 (in this instance, the request 138) from the hardware FIFO queue 34. Upon dispatching the request 138, the instruction processing circuit 12 uses the register identity <ID R₀> and the register content <Content R₀> of the request 138 to restore the values of one of the registers 24 in the hardware thread 20(0) corresponding to the register R₀ of the hardware thread 22(0). Program control in the hardware thread 20(0) is then transferred to the instruction 124 (referred to in this example as Instr₀) located at the address indicated by the parameter <return_address> of the request 138.

The efficient hardware dispatching of concurrent functions in multicore processors, and related processor systems, methods, and computer-readable media according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

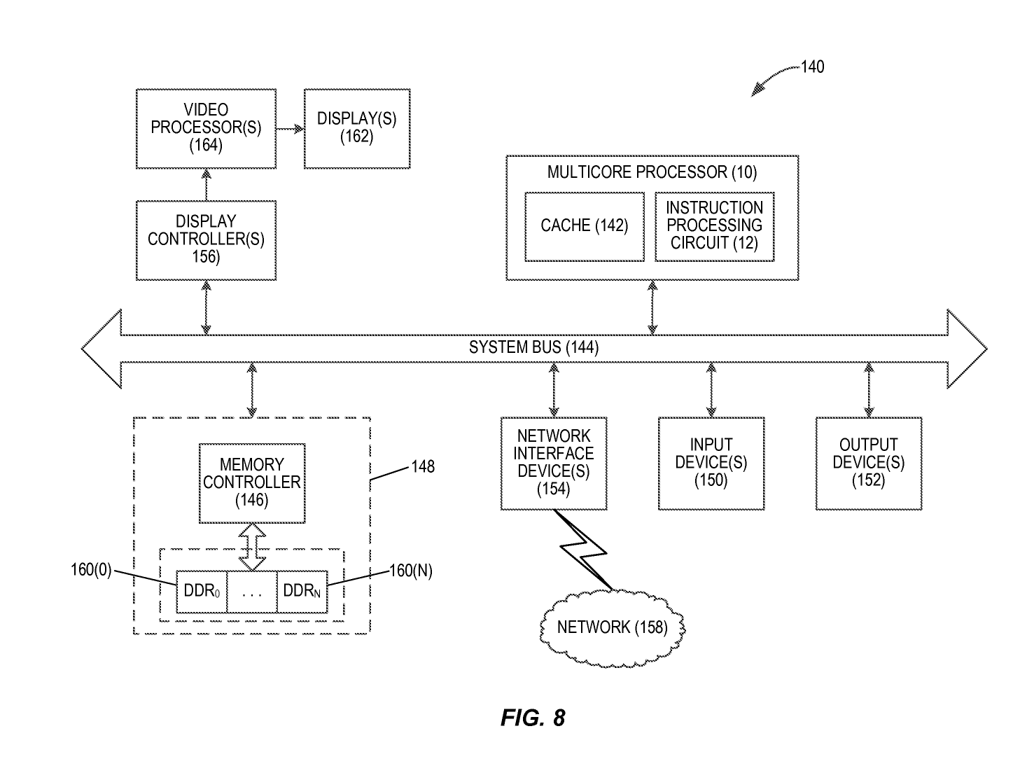

In this regard, FIG. 8 illustrates an example of a processor-based system 140 that can provide the multicore processor 10 and the instruction processing circuit 12 of FIG. 1. In this example, the multicore processor 10 may include the instruction processing circuit 12, and may have cache memory 142 for rapid access to temporarily stored data. The multicore processor 10 is coupled to a system bus 144 and can intercouple master and slave devices included in the processor-based system 140. As is well known, the multicore processor 10 communicates with these other devices by exchanging address, control, and data information over the system bus 144. For example, the multicore processor 10 can communicate bus transaction requests to a memory controller 146 as an example of a slave device. Although not illustrated in FIG. 8, multiple system buses 144 could be provided.

Other master and slave devices can be connected to the system bus 144. As illustrated in FIG. 8, these devices can include a memory system 148, one or more input devices 150, one or more output devices 152, one or more network interface devices 154, and one or more display controllers 156, as examples. The input device(s) 150 can include any type of input device, including but not limited to input keys, switches, voice processors, etc. The output device(s) 152 can include any type of output device, including but not limited to audio, video, other visual indicators, etc. The network interface device(s) 154 can be any devices configured to allow exchange of data to and from a network 158. The network 158 can be any type of network, including but not limited to a wired or wireless network, a private or public network, a local area network (LAN), a wide local area network (WLAN), and the Internet. The network interface device(s) 154 can be configured to support any type of communication protocol desired. The memory system 148 can include one or more memory units 160(0-N).

The multicore processor 10 may also be configured to access the display controller(s) 156 over the system bus 144 to control information sent to one or more displays 162. The display controller(s) 156 sends information to the display(s) 162 to be displayed via one or more video processors 164, which process the information to be displayed into a format suitable for the display(s) 162. The display(s) 162 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A multicore processor providing efficient hardware dispatching of concurrent functions, comprising:
a plurality of processing cores, the plurality of processing cores comprising a plurality of hardware threads;
a hardware first-in-first-out (FIFO) queue communicatively coupled to the plurality of processing cores; and
an instruction processing circuit configured to:
detect, in a first hardware thread of the plurality of hardware threads, a first instruction indicating an operation requesting a concurrent transfer of program control;
enqueue a request for the concurrent transfer of program control into the hardware FIFO queue;
detect, in a second hardware thread of the plurality of hardware threads, a second instruction indicating an operation dispatching the request for the concurrent transfer of program control in the hardware FIFO queue;
dequeue the request for the concurrent transfer of program control from the hardware FIFO queue; and
execute the concurrent transfer of program control in the second hardware thread.

2. The multicore processor of claim 1, wherein the instruction processing circuit is configured to enqueue the request for the concurrent transfer of program control by including, in the request, one or more register identities corresponding to one or more registers of the first hardware thread, and a register content of respective ones of the one or more registers.

3. The multicore processor of claim 2, wherein the instruction processing circuit is configured to dequeue the request for the concurrent transfer of program control by:
retrieving the register content of the respective ones of the one or more registers included in the request; and
restoring the register content of the respective ones of the one or more registers into a corresponding one or more registers of the second hardware thread prior to executing the concurrent transfer of program control.

4. The multicore processor of claim 1, wherein the instruction processing circuit is configured to enqueue the request for the concurrent transfer of program control by including, in the request, an identifier of a target hardware thread.

5. The multicore processor of claim 4, wherein the instruction processing circuit is configured to dequeue the request for the concurrent transfer of program control by determining that the identifier of the target hardware thread included in the request identifies the second hardware thread as the target hardware thread.

6. The multicore processor of claim 1, wherein the instruction processing circuit is further configured to:
determine whether the request for the concurrent transfer of program control was successfully enqueued; and
responsive to determining that the request for the concurrent transfer of program control was not successfully enqueued, raise an interrupt.

7. The multicore processor of claim 1 integrated into an integrated circuit.

8. The multicore processor of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

9. A multicore processor providing efficient hardware dispatching of concurrent functions, comprising:
a hardware first-in-first-out (FIFO) queue means;
a plurality of processing cores comprising a plurality of hardware threads and communicatively coupled to the hardware FIFO queue means; and
an instruction processing circuit means, comprising:
a means for detecting, in a first hardware thread of the plurality of hardware threads, a first instruction indicating an operation requesting a concurrent transfer of program control;
a means for enqueuing a request for the concurrent transfer of program control into the hardware FIFO queue means;
a means for detecting, in a second hardware thread of the plurality of hardware threads, a second instruction indicating an operation dispatching the request for the concurrent transfer of program control in the hardware FIFO queue means;
a means for dequeuing the request for the concurrent transfer of program control from the hardware FIFO queue means; and
a means for executing the concurrent transfer of program control in the second hardware thread.

10. A method for efficient hardware dispatching of concurrent functions, comprising:
detecting, in a first hardware thread of a multicore processor, a first instruction indicating an operation requesting a concurrent transfer of program control;
enqueuing a request for the concurrent transfer of program control into a hardware first-in-first-out (FIFO) queue;
detecting, in a second hardware thread of the multicore processor, a second instruction indicating an operation dispatching the request for the concurrent transfer of program control in the hardware FIFO queue;
dequeuing the request for the concurrent transfer of program control from the hardware FIFO queue; and
executing the concurrent transfer of program control in the second hardware thread.

11. The method of claim 10, wherein enqueuing the request for the concurrent transfer of program control comprises including, in the request, one or more register identities corresponding to one or more registers of the first hardware thread, and a register content of respective ones of the one or more registers.

12. The method of claim 11, wherein dequeuing the request for the concurrent transfer of program control comprises:
retrieving the register content of the respective ones of the one or more registers included in the request; and
restoring the register content of the respective ones of the one or more registers into a corresponding one or more registers of the second hardware thread prior to executing the concurrent transfer of program control.

13. The method of claim 10, wherein enqueuing the request for the concurrent transfer of program control comprises including, in the request, an identifier of a target hardware thread.

14. The method of claim 13, wherein dequeuing the request for the concurrent transfer of program control comprises determining that the identifier of the target hardware thread included in the request identifies the second hardware thread as the target hardware thread.

15. The method of claim 10, further comprising:
determining whether the request for the concurrent transfer of program control was successfully enqueued; and
responsive to determining that the request for the concurrent transfer of program control was not successfully enqueued, raising an interrupt.

16. A non-transitory computer-readable medium, having stored thereon computer-executable instructions to cause a processor to implement a method for efficient hardware dispatching of concurrent functions, the method comprising:
detecting, in a first hardware thread of a multicore processor, a first instruction indicating an operation requesting a concurrent transfer of program control;
enqueuing a request for the concurrent transfer of program control into a hardware first-in-first-out (FIFO) queue;
detecting, in a second hardware thread of the multicore processor, a second instruction indicating an operation dispatching the request for the concurrent transfer of program control in the hardware FIFO queue;
dequeuing the request for the concurrent transfer of program control from the hardware FIFO queue; and
executing the concurrent transfer of program control in the second hardware thread.

17. The non-transitory computer-readable medium of claim 16 having stored thereon the computer-executable instructions to cause the processor to implement the method, wherein enqueuing the request for the concurrent transfer of program control comprises including, in the request, one or more register identities corresponding to one or more registers of the first hardware thread, and a register content of respective ones of the one or more registers.

18. The non-transitory computer-readable medium of claim 17 having stored thereon the computer-executable instructions to cause the processor to implement the method, wherein dequeuing the request for the concurrent transfer of program control comprises:
retrieving the register content of the respective ones of the one or more registers included in the request; and
restoring the register content of the respective ones of the one or more registers into a corresponding one or more registers of the second hardware thread prior to executing the concurrent transfer of program control.

19. The non-transitory computer-readable medium of claim 16 having stored thereon the computer-executable instructions to cause the processor to implement the method, wherein enqueuing the request for the concurrent transfer of program control comprises including, in the request, an identifier of a target hardware thread.

20. The non-transitory computer-readable medium of claim 19 having stored thereon the computer-executable instructions to cause the processor to implement the method, wherein dequeuing the request for the concurrent transfer of program control comprises determining that the identifier of the target hardware thread included in the request identifies the second hardware thread as the target hardware thread.
